(19) United States
(12) Patent Application Publication
(10) Pub. No.: US 2022/0011755 A1
(43) Pub. Date: Jan. 13, 2022

(54) DEVICE AND METHOD FOR CONFIGURING A PRODUCTION MACHINE ON THE BASIS OF PRODUCT DATA

(71) Applicant: PHOENIX CONTACT GMBH & CO. KG, Blomberg (DE)

(72) Inventors: Sebastian FALTINSKI, Lemgo (DE); Mattes REITZ, Lemgo (DE); Sandro LIMBERG, Blomberg (DE); Marvin KURDE, Paderborn (DE)

(21) Appl. No.: 17/292,399

(22) PCT Filed: Nov. 8, 2019
(86) PCT No.: PCT/EP2019/080755

§ 371 Date: May 7, 2021

(30) Foreign Application Priority Data
Nov. 9, 2018 (BE) BE2018/5789

(51) Int. Cl. G05B 19/418

(52) U.S. Cl. CPC G05B 19/41845; G05B 2219/31103

(57) ABSTRACT

The present invention relates to an apparatus (100) for configuring a production machine based on product data, the apparatus (100) comprising: interface device (10) adapted to provide product data for a product to be produced; computer device (20) adapted to evaluate the product data and to generate configuration data for a machine configuration of the production machine based thereon; and control device (30) adapted to control the production machine based on the configuration data in order to produce the product.

### TECHNICAL FIELD

The present invention relates to systems for configuring a production machine in the field of computer aided manufacturing.

In particular, the present invention relates to an apparatus and method for configuring a production machine based on product data.

### TECHNICAL BACKGROUND

In the production of customized products, production machines may have a large number of parameters to be set and/or checked.

Manual teach-in operations or conventional set-up activities are therefore often laborious for freely configurable articles and require a corresponding manual changeover of the production machine based on a manual and laborious data input of production parameters.

### SUMMARY OF THE INVENTION

It is an object of the present invention to provide an improved apparatus and method for configuring a production machine based on product data.

This object is solved by the objects of the independent appended patent claims. Further embodiments and embodiments can be found in the dependent patent claims, the description and the figures of the drawings.

A first aspect of the present invention relates to a Apparatus for configuring a production machine based on product data, the apparatus comprising an interface device, a computer device and a control device.

The interface device is adapted to provide product data for a product to be produced.

The computer device is configured to evaluate the product data and, based thereon, to generate configuration data for a machine configuration of the production machine.

The computer device is adapted to control the production machine based on the configuration data in order to produce the product.

The present invention enables a parameterization of a production machine and/or an individual station to be derived during production of an article that is also configured individually for a customer.

Furthermore, for example, the method of the present invention can also be used to derive the execution and/or preparation of individual production steps from the neutral data format. This also includes, for example, an automatic selection of a suitable tool or robot head of the production machine for the article or the set-up instruction for the operator for manual adjustment of individual machine components.

This allows inventory items and also newly created customer-specific items to be produced without having to set up the article to be set up on the machine.

Even new articles that were not known when the machine was set up were known when the machine was set up, can be produced in this way.

The present invention enables production machines to be set up with required information being derived from product data, which is available in neutral data format, for example. This enables fast production of newly configured articles even without manual setting of the production system.

Further, advantageous embodiments of the present invention can be found in the dependent claims.

In an advantageous exemplary embodiment of the present invention, it is provided that the computer device is adapted to store as the configuration data for the machine configuration data relating to:

i) a selection of sub-units of the production machine to be used; and/or

ii) a selection of sub-units of the production machine to be switched on; and/or

iii) a selection of production machine sub-units to be switched off; and/or

iv) configuration settings for the sub-units of the production machine; and/or

v) a set-up instruction for an operator of the production machine.

In an advantageous exemplary embodiment of the present invention, it is provided that the interface device is further adapted to provide machine data of the production machine.

In an advantageous exemplary embodiment of the present invention, it is provided that the computer device is further adapted to generate the configuration data for the machine configuration based on the product data and the machine data.

In an advantageous exemplary embodiment of the present invention, it is provided that the interface device is adapted to store as the machine data in terms of data relating to:

i) a selection of production-ready, engaged subunits of the production machine; and/or

ii) a selection of switched-on sub-units of the production machine; and/or

iii) a selection of switched-off sub-units of the production machine; and/or

iv) a selection of total sub-units of the production machine; and/or

v) a selection of possible adjustments of the production machine; and/or

vi) a selection of possible set-up instructions to an operator of the production machine.

In an advantageous exemplary embodiment of the present invention, it is provided that the interface device is further adapted to provide component inventory data of the production machine, wherein the computer device is adapted to generate the configuration data for a machine configuration based on the product data and the machine data and the component inventory data.

In an advantageous exemplary embodiment of the present invention, it is provided that the interface device is adapted to generate, as the component inventory data, data on:

i) a selection of existing components of the production machine; and/or

ii) a number of existing components of the production machine.

In an advantageous exemplary embodiment of the present invention, it is provided that the interface device is adapted to provide the product data in a neutral data format, wherein preferably the neutral data format is a

i) XML format; and/or

ii) platform-independent data format; and/or

iii) implementation-independent data format; and/or

iv) M2M data format.

An M2M data format, also referred to as “machine to machine format” refers to data stored in a format that enables direct communication between two machines or data processing equipment, i.e., without the need for a human to start, execute, or monitor process steps.

In an advantageous exemplary embodiment of the present invention, it is provided that the device is adapted to communicate with the production machine via machine to machine communication data in the form of the product data and/or configuration data and/or machine data and/or component inventory data.

In an advantageous exemplary embodiment of the present invention, it is provided that the device is adapted to transmit the product data to the production machine for fine evaluation of the product data.

In an advantageous exemplary embodiment of the present invention, it is provided that the computing device is adapted to generate the configuration data for the machine configuration of the production machine further based on a setup time optimization of the production machine.

According to a second aspect of the present invention, a method for configuring a production machine based on product data is provided, wherein the method comprises the following method steps:

As a first method step, a product data for a product to be produced is provided by means of an interface device.

As a second method step, the product data is evaluated and, based thereon, configuration data for a machine configuration of the production machine is generated by means of a computer device.

As a third process step, the production machine is controlled on the basis of the configuration data by means of a control device in order to produce the product.

In an advantageous exemplary embodiment of the present invention, it is provided that the method further comprises the following method steps:

As a further step, providing data as the configuration data for a machine configuration by means of the interface device, wherein the data is about:

i) a selection of sub-units of the production machine to be used; and/or

ii) a selection of subunits of the production machine to be turned on; and/or

iii) a selection of subunits of the production machine to be turned off; and/or

iv) configuration settings for the sub-units of the production machine; and/or

v) a set-up instruction for an operator of the production machine.

In an advantageous exemplary embodiment of the present invention, it is provided that the method further comprises the following method steps:

As a further step, providing machine data of the production machine by means of the interface device; and

As a further step, generating configuration data for a machine configuration based on the product data and the machine data of the production machine by means of the computing device.

In an advantageous exemplary embodiment of the present invention, it is provided that the method further comprises the following method steps:

As a further step, providing data as the machine data by means of the interface device, wherein the data is provided via:

i) a selection of production-ready, engaged subunits of the production machine; and/or

ii) a selection of switched-on sub-units of the production machine; and/or

iii) a selection of switched-off sub-units of the production machine; and/or

iv) a selection of total sub-units of the production machine; and/or

v) a selection of possible adjustments of the production machine; and/or

vi) a selection of possible set-up instructions to an operator of the production machine.

In an advantageous exemplary embodiment of the present invention, it is provided that the method further comprises the following method steps:

As a further step, providing component inventory data of the production machine by means of the interface device Generating configuration data for the machine configuration based on the product data and the machine data and the component inventory data by means of the computing device.

According to a third aspect, the present invention comprises a data structure format comprising product data of the article preferably present in a neutral data format and adapted to be used by a method for configuring a production machine based on product data according to one of the second aspect or any embodiment of the second aspect.

The above described embodiments and further embodiments can be combined with each other as desired.

Other possible embodiments, further embodiments and implementations of the present invention also include combinations of features of the present invention described previously or hereinafter with respect to the embodiments that are not explicitly mentioned.

The accompanying drawings are intended to provide a further understanding of embodiments of the present invention.

The accompanying drawings illustrate embodiments and, in connection with the description, serve to explain concepts of the present invention.

Other embodiments and many of the advantages mentioned will be apparent with reference to the figures of the drawings. The elements shown in the figures of the drawings are not necessarily shown to scale with respect to each other.

### BRIEF DESCRIPTION OF THE FIGURES

FIG. 1: shows a schematic diagram of an apparatus for configuring a production machine based on product data according to an embodiment of the present invention; and

FIG. 2: shows a schematic diagram of a flowchart of a method for configuring a production machine based on product data according to an embodiment of the present invention; and

FIG. 3: shows a schematic representation of a data structure for configuring a production machine based on product data according to an embodiment example of the present invention.

### DETAILED DESCRIPTION OF THE EMBODIMENTS

In the figures of the drawings, identical reference signs denote identical or functionally identical elements, parts, components or process steps, unless otherwise indicated.

The term “neutral data format” as used by the present invention includes, for example, data or file formats for neutral file exchange between units, such as computers, of a computer network.

The term “neutral data format” as used by the present invention can be understood, for example, as an intermediate file format for translating data between participating systems of the computer network, such as production systems or ordering systems—webshop— or internal data processing systems—backend.

In other words, a neutral file is generated from original data available in other file formats. However, the target system can read and process the neutral file, unlike the original data.

For example, the term “product data”, in particular product data of the article, as used by the present invention describes data that defines and classifies an article, in particular according to customer-specific configuration. In other words, the product data describes and identifies parameters, characteristics, and design options of the article.

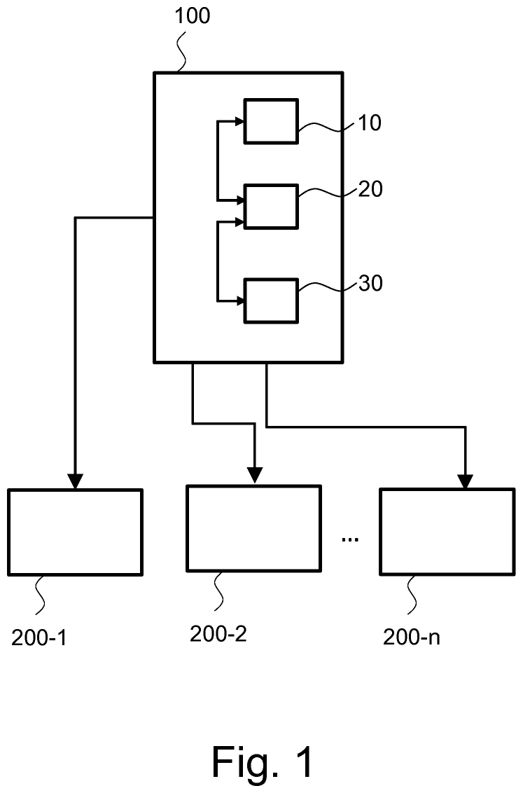

FIG. 1 shows a schematic representation of a device for configuring a production machine 200-1, 200-2, . . . , 200-n based on product data according to an exemplary embodiment of the present invention.

The apparatus 100 comprises an interface device 10, a computer device 20 and a control device 30.

The interface device 10 is adapted to provide product data for a product to be produced.

The computer device 20 is configured to evaluate the product data and, based thereon, to generate configuration data for a machine configuration of the production machine.

The control device 30 is configured to control the production machine based on the configuration data to produce the product.

The apparatus 100 may be coupled to a production machine 200-1 or to a plurality of production machines 200-1, 200-2, . . . , 200-n, as shown.

The present method and the apparatus 100 enable setup instructions, production steps, and adjustments to be made to production machines 200-1, 200-2, . . . , 200-n in an automated manner to produce a plurality of different and freely configurable articles with high throughput and low interruptions.

The apparatus 100 can be coupled with computer-aided product manufacturing system and internet-based product configuration systems to provide autonomous and customizable production systems via M2M communication.

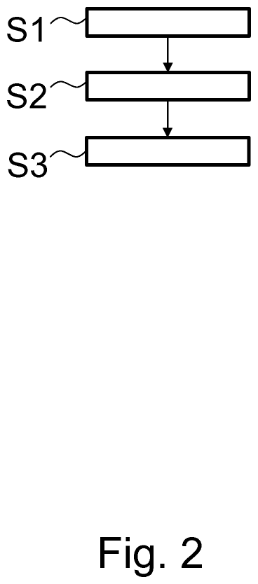

FIG. 2 shows a schematic diagram of a flowchart of a method for configuring a production machine based on product data, according to an exemplary embodiment of the present invention.

As a first method step, a providing S1 of product data for a product to be produced is performed by means of an interface device, for example the product data is stored in a neutral data format.

The neutral data format can be, for example, an XML format, a platform-independent data format, an implementation-independent data format or an M2M data format.

As a second process step, the product data is evaluated S2 and configuration data for a machine configuration of the production machine is generated on this basis by means of a computer device.

As a third process step, the production machine is controlled S3 based on the configuration data by means of a control device in order to produce the product.

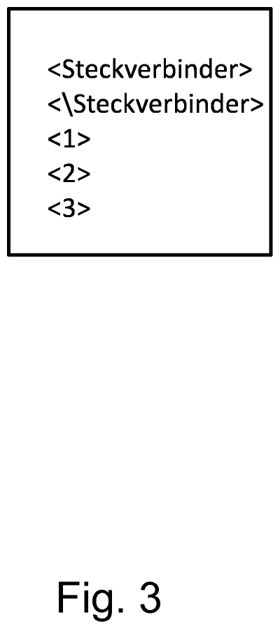

FIG. 3 shows a schematic representation of a data structure for configuring a production machine based on product data according to an exemplary embodiment of the present invention.

The data structure format shown in FIG. 3 may comprise product data of the article present in a neutral data format. Further, the data structure format may be adapted to be used by a method for checking a printing of an article.

Further, in the illustrated data structure format, the neutral data format may comprise for example an

i) XML format; and/or

ii) platform-independent data format; and/or

iii) implementation-independent data format; and/or

iv) M2M data format.

The data structure format may further comprise hierarchically structured product data in the format of a text file.

Although the present invention has been described above with reference to preferred embodiments, it is not limited thereto, but can be modified in a variety of ways. In particular, the invention can be changed or modified in a variety of ways without departing from the essence of the invention.

Additionally, it should be noted that “comprising” and “comprising” do not exclude other elements or steps, and “one” or “a” do not exclude a plurality.

It should further be noted that features or steps that have been described with reference to any of the above embodiments may also be used in combination with other features or steps of other embodiments described above. Reference signs in the claims are not to be regarded as a limitation.

1. An apparatus for configuring a production machine based on product data, the apparatus comprising:
an interface device, which is designed to provide product data for a product to be produced;
a computer device adapted to evaluate the product data and, based thereon, to generate configuration data for a machine configuration of the production machine; and
a control device adapted to control the production machine based on the configuration data to produce the product.

2. The apparatus according to claim 1, wherein the computer device is adapted to store, as the configuration data for the machine configuration, data including. at least one of:
i) a selection of sub-units of the production machine to be used;
ii) a selection of sub-units of the production machine to be turned on;
iii) a selection of sub-units of the production machine to be switched off;
iv) configuration settings for the sub-units of the production machine; or
v) a set-up instruction for an operator of the production machine.

3. The apparatus according to claim 1, wherein the interface device is further adapted to provide machine data of the production machine, and wherein the computer device is further adapted to generate the configuration data for the machine configuration based on the product data and the machine data.

4. The apparatus according to claim 3, wherein the interface device is adapted to generate, as the machine data, data including at least one of:
i) a selection of production-ready, engaged subunits of the production machine;
ii) a selection of switched-on sub-units of the production machine;
iii) a selection of switched-off sub-units of the production machine;
iv) a selection of total sub-units of the production machine;
v) a selection of possible adjustments of the production machine; or
vi) a selection of possible set-up instructions to an operator of the production machine.

5. The apparatus according to claim 1, wherein the interface device is further adapted to provide component inventory data of the production machine, and wherein the computer device is adapted to generate the configuration data for a machine configuration based on the product data and the machine data and the component inventory data.

6. The apparatus according to claim 5, wherein the interface device is adapted to generate, as the component inventory data, data including at least one of:
i) a selection of existing components of the production machine; or
ii) a number of existing components of the production machine.

7. The apparatus according to claim 1, wherein the interface device is adapted to provide the product data in a neutral data format, and wherein the neutral data format includes at least one of:
i) an XML format;
ii) a platform-independent data format; or
iii) an implementation-independent data format; or
iv) an M2M data format

8. The apparatus according to claim 1, wherein the device is adapted to communicate with the production machine via machine-to-machine communication data in the form of the product data or configuration data or machine data or component inventory data.

9. The apparatus according to claim 1, wherein the apparatus is adapted to transmit the product data to the production machine for fine evaluation of the product data.

10. The apparatus according to claim 1, wherein the computer device is adapted to generate the configuration data for the machine configuration of the production machine further based on a setup time optimization of the production machine.

11. A method for configuring a production machine based on product data, the method including steps comprising:
providing product data for a product to be produced using an interface device;
evaluating the product data and, based thereon, generating configuration data for a machine configuration of the production machine using a computer device; and
driving the production machine based on the configuration data using a control device to produce the product.

12. A method according to claim 11, wherein the method further includes steps comprising:
providing data as the configuration data for a machine configuration using the interface device, and wherein the data includes at least one of:
i) a selection of sub-units of the production machine to be used;
ii) a selection of subunits of the production machine to be turned on;
iii) a selection of subunits of the production machine to be turned off;
iv) configuration settings for the sub-units of the production machine; or
v) a set-up instruction for an operator of the production machine.

13. A method according to claim 11, wherein the method further includes steps comprising:
providing machine data of the production machine using the interface device; and
generating configuration data for a machine configuration based on the product data and the machine data of the production machine using the computing device.

14. A method according to claim 13, wherein the method further includes steps comprising:
providing data as the machine data using the interface device, the data comprising:
i) a selection of production-ready, engaged subunits of the production machine;
ii) a selection of switched-on sub-units of the production machine;
iii) a selection of switched-off sub-units of the production machine;
iv) a selection of total sub-units of the production machine;
v) a selection of possible adjustments of the production machine; or
vi) a selection of possible set-up instructions to an operator of the production machine.

15. A method according to claim 11, wherein the method further includes steps comprising:
providing component inventory data of the production machine using the interface device; and
generating the configuration data for the machine configuration based on the product data and the machine data and the component inventory data using the computing device.
